(19) United States
(12) Patent Application Publication
(10) Pub. No.: US 2025/0207931 A1
(43) Pub. Date: Jun. 26, 2025

(54) ROUTE GUIDANCE SYSTEM

(71) Applicant: TOYOTA JIDOSHA KABUSHIKI KAISHA, Toyota-shi (JP)

(72) Inventors: Daishi Sanada, Toyota-shi (JP); Akiyuki Okamoto, Okazaki-shi (JP); Shingo Maeda, Okazaki-shi (JP); Takayuki Akaishi, Toyota-shi (JP); Isao Honda, Chiryu-shi (JP)

(73) Assignee: TOYOTA JIDOSHA KABUSHIKI KAISHA, Toyota-shi (JP)

(21) Appl. No.: 18/967,875

(22) Filed: Dec. 4, 2024

(30) Foreign Application Priority Data
Dec. 22, 2023 (JP) 2023-216885

(51) Int. Cl. G01C 21/34; G01C 21/36

(52) U.S. Cl. CPC G01C 21/3492; G01C 21/3469; G01C 21/3679; G01C 21/3691

(57) ABSTRACT

The route guidance system includes a navigation device and a management server. The management server has a congestion status database that stores the congestion status of hydrogen stations. The navigation device acquires the congestion status of the hydrogen station from the congestion status database of the management server and estimates the waiting time period at the hydrogen station. Then, the navigation device searches for a filling station inclusive driving route for each hydrogen station. Then, the navigation device calculates the required time period to the destination including the waiting time period for each of the searched filling station inclusive driving routes. The navigation device then provides route guidance using the filling station inclusive driving route with the shortest required time period.

### CROSS REFERENCE TO RELATED APPLICATION

This application claims priority to Japanese Patent Application No. 2023-216885 filed on Dec. 22, 2023, which is incorporated herein by reference in its entirety including the specification, claims, drawings, and abstract.

### DESCRIPTION

### Technical Field

The present disclosure relates to a route guidance system that searches for a driving route to a destination via an energy filling station and provides route guidance using the searched driving route.

### Background

JPA 2014-500697 discloses a system that retrieves information from a database about the current availability of charging stations and the compatibility of chargers with vehicles, and indicates a driving route to a charging station with available chargers that are compatible with the vehicle. In this system, if the nearest charging station is not available, the system searches for the next nearest charging station.

Also, JPA 2017-91427 relates to a system for replacing battery packs on electric two-wheelers at a battery station. The battery station charges the battery and provides it as a charged battery pack. Therefore, it takes time until a charged battery pack can be provided. In the system described in the literature 2, the exchange completion time is calculated based on the time until each battery station can prepare a charged battery pack, the travel time to the battery station, and the waiting time period calculated based on the congestion at the battery station. The time to complete the exchange is then calculated on the screen. The current position of the electric two-wheeler, the time until arrival at each battery station, and the replacement completion time are then displayed on the screen.

### SUMMARY

By the way, energy filling stations such as hydrogen stations and charging stations are still in the process of spreading, and the number of locations and units installed are fewer than those of conventional gas stations. On the other hand, the time required for hydrogen filling and battery charging is longer than the time required for refueling. Therefore, vehicles may be concentrated at energy filling stations, and it may take longer to fill hydrogen gas and charge batteries. In addition, energy filling stations may be out-of-service for maintenance, which may result in additional route travel through other energy filling stations. In this case, the required time period for driving to the destination with energy filling along the way becomes longer.

In this regard, the systems described in JPA 2014-500697 and JPA 2017-91427 do not take into account the required time period to the destination.

Therefore, the purpose of this disclosure is to shorten the required time period for driving to the destination with energy filling on the way.

The route guidance system of this disclosure comprising: a navigation device that searches for a driving route to a destination based on the destination and a transit point, and provides route guidance using the searched driving route, the navigation device including a processor that performs information processing; and a management server that manages an operational status of a plurality of energy filling stations, and stores a congestion status database in a memory that stores information, the congestion status database storing a congestion status of each of the plurality of energy filling stations. The processor obtains the congestion status of each of the plurality of energy filling stations from the congestion status database of the management server; and estimates a waiting time period at each of the plurality of energy filling stations based on the obtained congestion status; for each of the plurality of energy filling stations, searches for a filling station inclusive driving route incorporating one of the plurality of energy filling stations as the transit point; and calculates a required time period to reach the destination, including the waiting time period, for each of the searched filling station inclusive driving routes; and provides the route guidance using the filling station inclusive driving route with the shortest required time period.

Thus, the route guidance system estimates the waiting time period at the energy filling station based on the congestion situation, and guides the route by using a route with the shortest required time period to the destination including the waiting time period at the energy filling station. This allows the user to shorten the required time period when driving to the destination by filling up energy in the middle of the driving route.

The route guidance system of this disclosure, the memory of the management server may store a service information database that includes a location and service information of each of the plurality of energy filling stations.

The processor may search for a reference driving route to the destination based on the destination and the transit point; may obtain the location of each of the plurality of energy filling stations from the service information database of the management server; may search for a plurality of energy filling stations located in the vicinity of the reference driving route; and may set the searched plurality of energy filling stations as a plurality of filling station candidates. The obtaining the congestion status of each of the plurality of energy filling stations may be to obtain the congestion status of each of the plurality of filling station candidates from the congestion status database of the management server. The estimating of the waiting time period may be to estimate the waiting time period at each of the plurality of filling station candidates based on the obtained congestion status. The searching for the filling station inclusive driving route may be to search for the filling station inclusive driving route incorporating one of the plurality of filling station candidates as the transit point for each of the plurality of filling station candidates.

This enables route guidance so that the required time period to the destination, including the waiting time period, is minimized via energy filling stations located in the vicinity of the reference driving route.

The route guidance system of this disclosure, the processor may obtain the service information of each of the plurality of filling station candidates from the service information database of the management server after setting the plurality of filling station candidates, and may reset the plurality of filling station candidates by excluding out-of-service filling station candidates from the plurality of filling station candidates. The obtaining of the congestion status of each of the plurality of energy filling stations may be to obtain the congestion status of each of the plurality of reset filling station candidates from the congestion status database of the management server. The estimating of the waiting time period may be to estimate the waiting time period at each of the reset filling station candidates based on the obtained congestion status. The searching for the filling station inclusive driving route may be to search for the filling station inclusive driving route incorporating one of the reset filling station candidates as the transit point for each of the plurality of reset filling station candidates.

Thus, since out-of-service energy filling stations are excluded from filling station candidates, it is possible to suppress route guidance by driving routes via out-of-service energy filling stations. This also prevents additional routes from being traveled via other energy filling stations.

The route guidance system of this disclosure, in the congestion status database, the congestion status of each of the plurality of energy filling stations may be associated with the day of the week and the time of day. The processor may search a partial driving route to the plurality of reset filling station candidates and may calculate the arrival time at each of the plurality of reset filling station candidates. The estimating of the waiting time period may be to refer to the congestion status database and estimate the waiting time period at the arrival time to the reset filling station candidate.

This allows the navigation device to accurately estimate the waiting time period for each reset filling station candidate.

The route guidance system of this disclosure, the energy filling station may be a charging station or a hydrogen station.

This shortens the required time period for driving to the destination after charging or filling up with hydrogen gas in the middle of the driving route.

This disclosure can shorten the required time period for driving to the destination with energy refueling along the way.

### BRIEF DESCRIPTION OF DRAWINGS

FIG. 1 is a system diagram of the route guidance system of the embodiment;

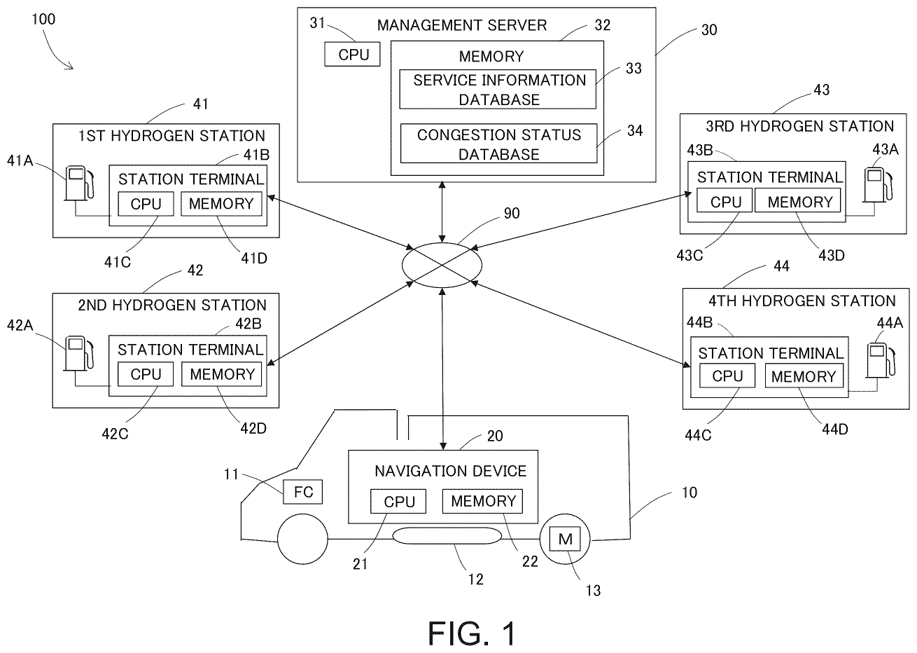

FIG. 2 shows the data structure of the service information database stored in the memory of the management server shown in FIG. 1;

FIG. 3 shows the data structure of the congestion status database stored in the memory of the management server shown in FIG. 1;

FIG. 4 is a flowchart showing the operation of the navigation device shown in FIG. 1;

FIG. 5 shows a reference driving route from the starting point to the destination and multiple filling station inclusive driving routes from the starting point to the destination;

FIG. 6 is a summary table of the results of the operation of the navigation device shown in FIG. 1;

FIG. 7 is a flowchart showing other operations of the navigation device shown in FIG. 1;

FIG. 8 is a flowchart showing other operations of the navigation device shown in FIG. 1;

FIG. 9 is a flowchart showing other operations of the navigation device shown in FIG. 1.

### DESCRIPTION OF EMBODIMENTS

The route guidance system 100 of the embodiment is described below with reference to the drawings. In the following description, a plurality of energy filling stations will be described as a plurality of hydrogen stations.

The route guidance system 100 includes a navigation device 20 and a management server 30.

The navigation device 20 is mounted on a fuel cell electric vehicle 10 (hereinafter referred to as FCEV), which contains a fuel cell unit 11, a hydrogen tank 12, and a drive motor 13. FCEV 10 is an electric vehicle powered by a hydrogen fuel cell. In the embodiment, FCEV10 is described as a fuel cell electric truck.

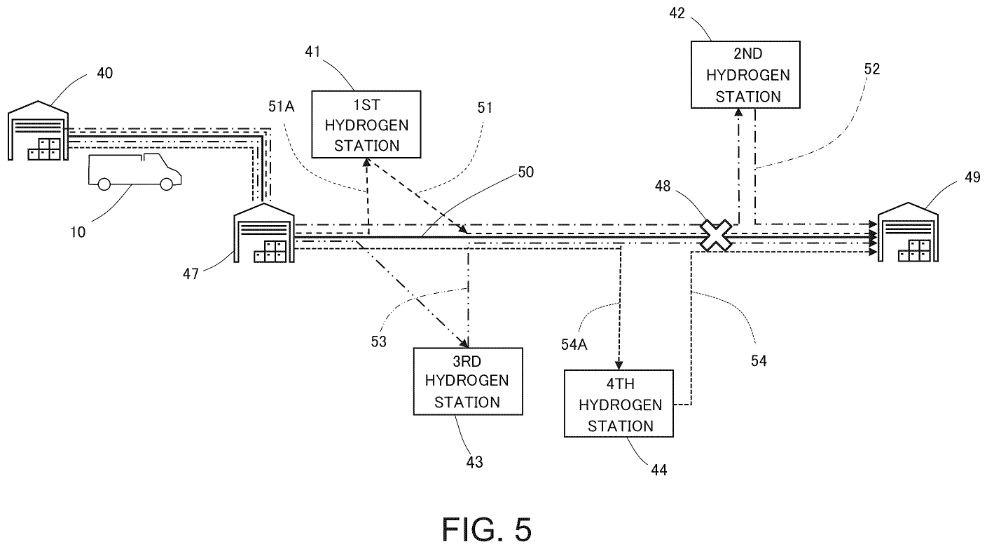

The navigation device 20 searches for a driving route to the destination 49 based on the destination 49 and transit point 47, and provides route guidance using the searched driving route (see FIG. 5). The navigation device 20 is a computer with a CPU 21, which is a processor that processes information, and a memory 22 that stores control data and control programs. The navigation device 20 acquires the current position based on GPS signals received from GPS satellites (not shown) and searches for a driving route to the destination 49 while referring to map data (not shown) stored in the memory 22. The navigation device 20 then displays the searched travel route together with the current position on a display (not shown). The navigation device 20 communicates with the management server 30 via the Internet line 90 to exchange information.

The management server 30 manages the operational status of the four hydrogen stations 41, 42, 43, and 44, the first through fourth hydrogen stations. The management server 30 is a computer that includes a CPU 31, which is a processor that processes information, and a memory 32 that stores programs and control data. The service information database 33 and the congestion status database 34 are stored in memory 32. These databases will be explained later.

The first hydrogen station 41 is equipped with one or more dispensers 41A, a station terminal 41B, and a high-pressure hydrogen tank (not shown). The dispenser 41A fills the hydrogen tank 12 of the FCEV 10 with high-pressure hydrogen gas stored in the high-pressure hydrogen tank. The station terminal 41B is connected to the dispenser 41A. The station terminal 41B is input with operating information including the operating status of the dispenser 41A or the amount of hydrogen gas filled. Station terminal 41B is a computer that includes a CPU 41C, which is a processor that processes information, and a memory 41D that stores control data and programs. The memory 41D stores service information including the location of the first hydrogen station 41, business days, regular holidays, business hours, telephone number, and service status. The service status is information on whether the station is out-of-service due to maintenance or normal operation. Station terminal 41B is connected to management server 30 via Internet line 90. Station terminal 41B transmits the operating information of dispenser 41A and the service information of the first hydrogen station 41 to the management server 30.

The second hydrogen station 42, third hydrogen station 43, and fourth hydrogen station 44 have the same configuration as the first hydrogen station 41. The second hydrogen station 42 has a dispenser 42A and a station terminal 42B. Station terminal 42B is a computer with an internal processor, CPU 42C, and memory 42D. Similarly, the third hydrogen station 43 is equipped with a dispenser 43A and a station terminal 43B. Station terminal 43B is a computer with an internal processor, CPU 43C, and memory 43D. Similarly, the fourth hydrogen station 44 is equipped with a dispenser 44A and a station terminal 44B. Station terminal 44B is a computer with a CPU 44C and memory 44D inside. The operating information of each dispenser 42A, 43A, 44A is input to each station terminal 42B, 43B, 44B. The memory 42D, 43D, and 44D of each station terminal 42B, 43B, and 44B stores service information for the second through fourth hydrogen stations 42, 43, and 44, as does the memory 41D of station terminal 41B. Each station terminal 42B, 43B, 44B transmits to the management server 30 the operation information of each dispenser 42A, 43A, 44A and the service information of the second to fourth hydrogen stations 42, 43, 44, just like the station terminal 41B.

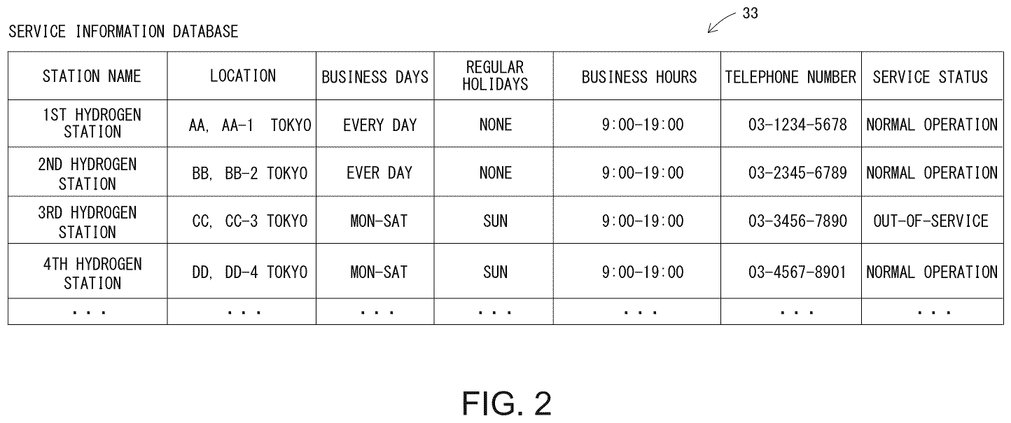

The management server 30 stores the service information of the first through fourth hydrogen stations 41, 42, 43, and 44 received from each station terminal 41B, 42B, 43B, and 44B in the service information database 33. As shown in FIG. 2, the service information database 33 is a database that stores the location, business days, regular holidays, business hours, telephone number, and service status of each hydrogen station in association with each hydrogen station. As explained earlier, service status is information on whether the station is out-of-service due to maintenance or normal operation.

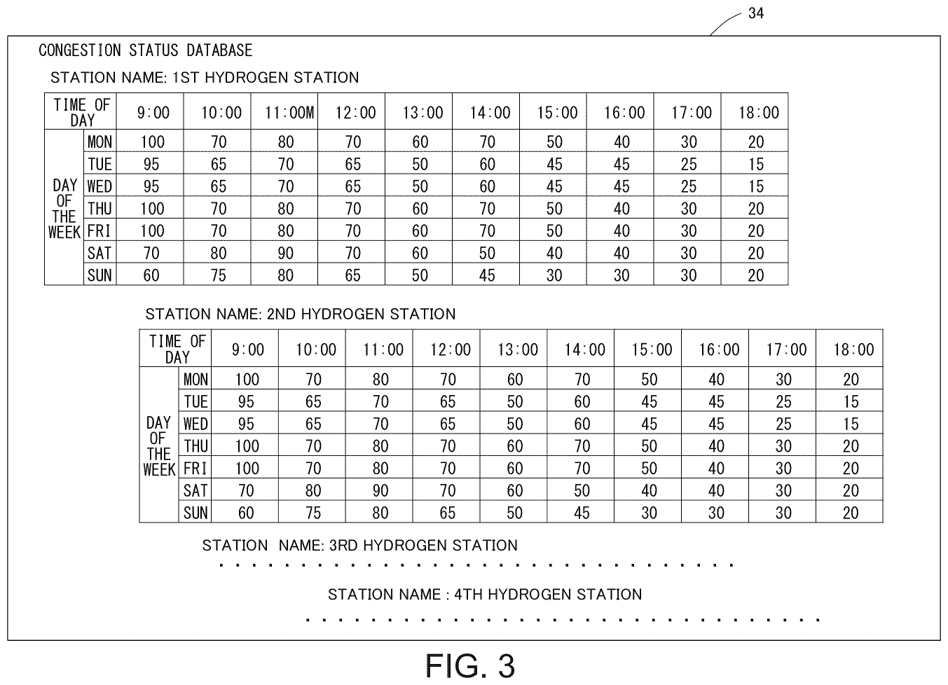

Based on the operation information of each dispenser 41A, 42A, 43A, 44A received from each station terminal 41B, 42B, 43B, 44B, the management server 30 calculates the congestion status for the first through fourth hydrogen stations 41, 42, 43, 44 for the day of the week and time of day, and stores it in the congestion status database 34. As shown in FIG. 3, congestion status database 34 is a database that associates each congestion status with the day of the week and time of day for each hydrogen station.

In the route guidance system 100 of the embodiment, a time period is a one-hour time period, for example, 9:00 (9:00-9:59), but it may be a two-hour time period. Congestion is also an indicator of the degree of congestion during that time period. For example, it may be a statistically processed index of the ratio of the number of FCEV 10 actually filled with hydrogen gas to the maximum number of FCEV 10 that can be filled with hydrogen gas during a calculated one-hour period. In this case, an index of 100 at 9:00 in FIG. 3 shows that at 9:00, the same number (100%) of FCEV10s come to fill up with hydrogen gas as the maximum number of FCEV10s that can be filled up with hydrogen gas in one hour for calculation purposes. The index of 60 at 13:00 shows that at 13:00, 60% of the maximum number of FCEV10 that can be filled with hydrogen gas during a calculated one-hour period will come to fill up with hydrogen gas. As explained later, the waiting time period to start filling at each time period can be estimated from this index. The congestion status database 34 shown in FIG. 3 may be updated periodically, for example, once a month, based on the operation information of each dispenser 41A, 42A, 43A, 44A received from each station terminal 41B, 42B, 43B, 44B.

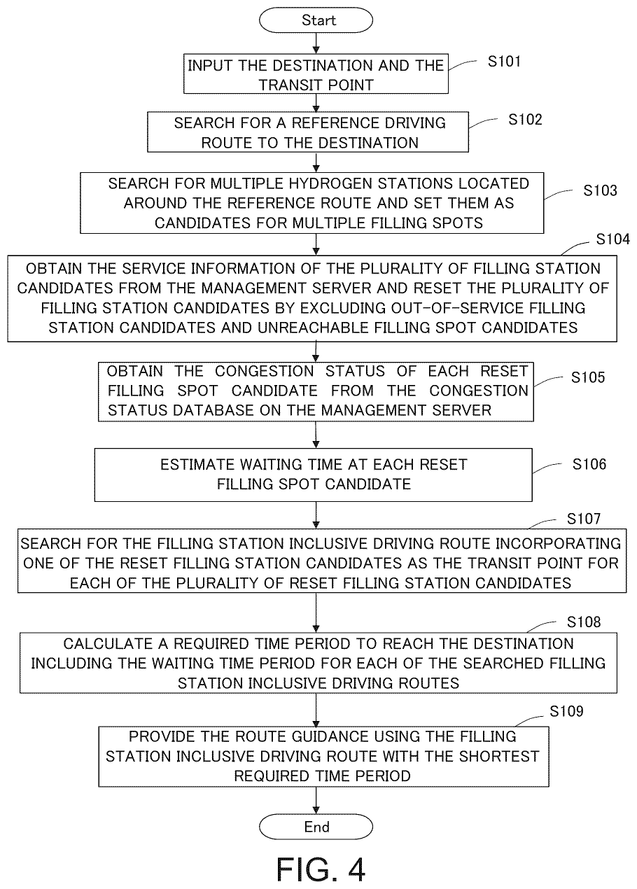

The operation of the navigation device 20 of the route guidance system 100 will now be described with reference to FIGS. 4 and 5. The following explanation describes the route guidance in the case where the FCEV 10 travels from the starting point 40 to the destination 49 via one of the first through fourth hydrogen stations 41, 42, 43, and 44 as shown in FIG. 5.

The occupants of the FCEV 10 input the destination 49 and the transit point 47 to the navigation device 20 before departure. When the destination 49 and transit point 47 are entered in step S101 of FIG. 4, the navigation device 20 proceeds to step S102 of FIG. 4 to search for a reference driving route 50 to the destination 49. The reference driving route 50 is the driving route when driving from the starting point 40 to the destination 49 via the transit point 47 without filling up with hydrogen gas on the way.

Next, the navigation device 20 obtains the location of each hydrogen station from the service information database 33 of the management server 30 in step S103 of FIG. 4, and searches for multiple hydrogen stations located around the reference driving route 50. Then, the first to fourth hydrogen stations 41, 42, 43, and 44 shown in FIG. 5 are set as candidates for multiple filling stations.

Next, the navigation device 20 proceeds to step S104 in FIG. 4 to obtain service information for the first through fourth hydrogen stations 41, 42, 43, and 44 from the service information database 33 of the management server 30. As shown in FIG. 2, the first, second, and fourth hydrogen stations 41, 42, and 44 are in normal operation, but the third hydrogen station 43 is out-of-service due to maintenance or other reasons. Therefore, the navigation device 20 excludes the third hydrogen station 43 from the candidate filling stations.

The navigation device 20 calculates the energy shortage point 48 where the FCEV 10 runs out of energy (hydrogen gas) in the reference driving route 50. The second hydrogen station 42, which is located farther away than the energy shortage point 48, is a candidate for an unreachable filling station that cannot be reached without filling up with hydrogen gas on the way.

Therefore, the navigation device 20 excludes the second and third hydrogen stations 42 and 43 from the filling station candidates in step S104 of FIG. 4, and resets the first and fourth hydrogen stations 41 and 44 as filling station candidates.

Next, the navigation device 20 obtains the congestion status of the reconfigured first and fourth hydrogen stations 41, 44 from the congestion status database 34 of the management server 30 in step S105 of FIG. 4. Then, based on the obtained congestion status, the navigation device 20 estimates the waiting time period until the start of hydrogen filling at the first and fourth hydrogen stations 41, 44 in step S106 of FIG. 4. The time period estimated to reach the first and fourth hydrogen stations 41, 4 may be selected and calculated based on the index of the selected time period.

The waiting time period may be estimated, for example, if the index of the selected time period is less than 50, the waiting time period is 0 minutes, and if the index is greater than 50, the waiting time period may be estimated as increasing by 1 minute for every 1 increase in the index. In this case, if the index of congestion at the first hydrogen station 41 is 80, the waiting time period at the first hydrogen station 41 is estimated to be 30 minutes, and if the index of congestion at the fourth hydrogen station 44 is 40, the waiting time period at the fourth hydrogen station 44 is 0 minutes.

Next, the navigation device 20 searches for a first filling station inclusive driving route 51 that travels to the destination 49 via the transit point 47 and the first hydrogen station 41 in step S107 of FIG. 4. Similarly, the navigation device 20 searches for a fourth filling station inclusive driving route 54 that travels to the destination 49 via the transit point 47 and the fourth hydrogen station 44.

Next, in step S108 of FIG. 4, the navigation device 20 calculates the required time period for driving to the destination 49 on the first filling station inclusive driving route 51. The required time period is 5 hours and 30 minutes, which is the total of 4 hours and 40 minutes of driving time to the destination 49, a waiting time period of 30 minutes until the start of hydrogen filling at the first hydrogen station 41, and the hydrogen filling time, for example, 20 minutes. Similarly, the navigation device 20 calculates the required time period for driving to destination 49 on the fourth filling station inclusive driving route 54. The required time period is 4 hours and 50 minutes, which is the total of 4 hours and 30 minutes of driving time to destination 49, a waiting time period of 0 minutes to start hydrogen filling at the fourth hydrogen station 44, and hydrogen filling time, for example, 20 minutes.

The navigation device 20 then provides route guidance using the fourth filling station inclusive driving route 54, which has the shortest required time period among the first filling station inclusive driving route 51 and the fourth filling station inclusive driving route 54 in step S109 of FIG. 4.

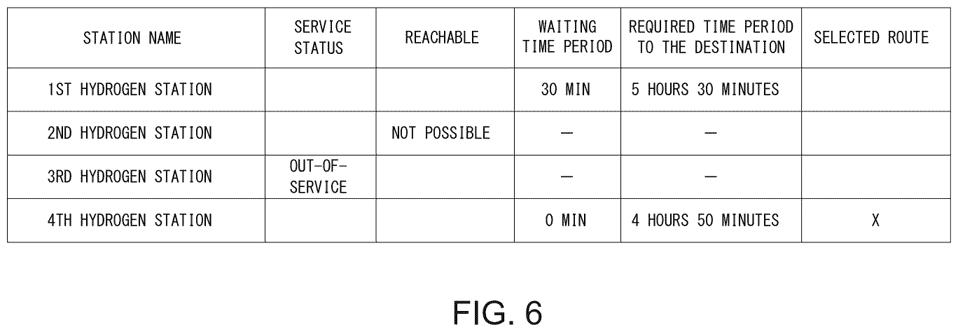

The operation of the navigation device 20 described above is summarized in a table as shown in FIG. 6. The first through fourth hydrogen stations 41, 42, 43, and 44 are set as multiple filling station candidates in step S103 of FIG. 4, so “first hydrogen station” through “fourth hydrogen station” are stored in the station names.

In step S104 of FIG. 4, the third hydrogen station 43 is excluded from the filling station candidates with out-of-service, and the second hydrogen station 42 is excluded from the filling station candidates with unreachable. Therefore, “out-of-service” is stored in the service status column of the third hydrogen station 43. In addition, “not possible” is stored in the column of reachability of the second hydrogen station 42. The waiting time period and required time period for the second and third hydrogen stations 42 and 43 are not calculated. Therefore, “-” is stored in these columns. On the other hand, the waiting time period and required time period for the first hydrogen station 41 and the fourth hydrogen station 44 have been estimated and calculated in steps S106 to S108 of FIG. 4, as they were reconfigured as filling station candidates. Therefore, these waiting time period columns and required time period columns contain the numerical values. Then, since the fourth filling station inclusive driving route 54 with the shortest required time period is selected in step S109 of FIG. 4, “X” is stored in the column of the selected route for the fourth hydrogen station 44.

As explained above, the route guidance system 100 of the embodiment estimates waiting time periods at the first to fourth hydrogen stations 41, 42, 43, and 44 based on congestion conditions. Then, the route guidance system 100 provides route guidance using a filling station inclusive driving route that has the shortest required time period to the destination 49 including waiting time periods at the first to fourth hydrogen stations 41, 42, 43, and 44. As a result, the route guidance system 100 can shorten the required time period for driving to the destination 49 by filling up with hydrogen gas in the middle of the driving route.

The route guidance system 100 of the embodiment sets the first to fourth hydrogen stations 41, 42, 43, 44 around the reference driving route 50 as filling station candidates. Then, the route guidance is guided so that the required time period including waiting time periods of the first to fourth hydrogen stations 41, 42, 43, and 44 set as filling station candidates is the shortest. This enables route guidance so that the required time period to destination 49, including waiting time period, is the shortest via hydrogen stations located in the vicinity of the reference driving route 50.

The route guidance system 100 of the embodiment also excludes the out-of-service third hydrogen station 43 and the unreachable second hydrogen station 42 from the candidate filling stations. This prevents the route guidance from being performed via out-of-service or unreachable second and third hydrogen stations 42 and 43. This also prevents additional routes via other hydrogen stations from being taken.

In the above description, the navigation device 20 excluded the second and third hydrogen stations 42 and 43 from the filling station candidates. On the other hand, if the navigation device 20 does not exclude the second and third hydrogen stations 42 and 43 from the filling station candidates, the navigation device 20 searches for a second filling station inclusive driving route 52 and a third filling station inclusive driving route 53 that travels to the destination 49 via the second or third hydrogen stations 42 and 43. The navigation device 20 searches for the second filling station inclusive driving route 52 and the third filling station inclusive driving route 53, and estimates and calculates the waiting time period and the required time period. Then, in step S109 of FIG. 4, the navigation device 20 provides route guidance using the filling station inclusive driving route with the shortest required time period among the first to fourth filling station inclusive driving routes 51, 52, 53, and 54.

In the above explanation, the navigation device 20 is described as being installed in the FCEV 10, but it is not limited to this. For example, it can be a smartphone equipped with navigation functions brought into the FCEV 10.

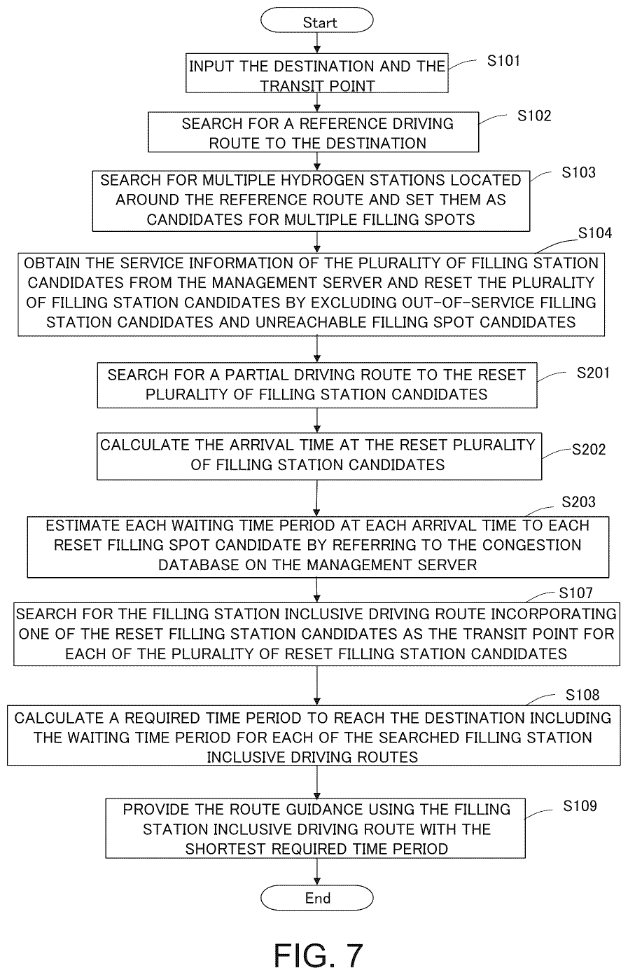

Next, other operations of the navigation device 20 will be described with reference to FIG. 7. Operations similar to those described earlier with reference to FIG. 4 will be marked with the same step numbers and omitted from the description.

After excluding the second and third hydrogen stations 42 and 43 from the filling station candidates in step S104 of FIG. 7, the navigation device 20 searches for partial driving routes 51A and 54A from the starting point 40 to the first and fourth hydrogen stations 41 and 44 in step S201 of FIG. 7. The navigation device 20 then calculates the arrival time at the first and fourth hydrogen stations 41 and 44 in step S202 of FIG. 7. The navigation device 20 estimates the waiting time period based on the index of congestion during the time period that includes the estimated arrival time calculated in step S203 of FIG. 7.

This operation can estimate the waiting time period more accurately than the operation described earlier with reference to FIG. 4.

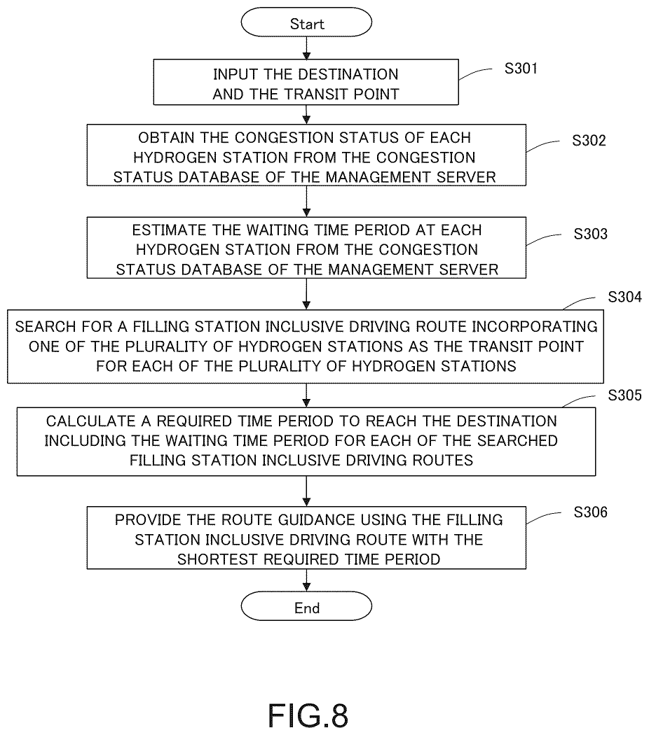

The other operations of the navigation device 20 are described next with reference to FIG. 8. Operations similar to those described earlier with reference to FIG. 4 will be briefly described.

If the route from the starting point 40 to the destination 49 via the transit point 47 is a route that has been traveled before, the hydrogen stations as filling station candidates are known and their service status is known. In this case, the navigation device 20 estimates the waiting time period from the congestion status of each hydrogen station without searching the reference driving route 50, setting the candidate filling stations, and resetting the candidate filling stations. The navigation device 20 may then search for a filling station inclusive driving route for each hydrogen station and provide guidance on the filling station driving route that has the shortest required time period to the destination 49. The operation of the navigation device 20 in this case is described with reference to FIG. 8.

As shown in step S301 of FIG. 8, the navigation device 20 refers to the past driving results once the destination 49 and the transit point 47 are input in step S101 of FIG. 4. From the past driving results, the navigation device 20 sets the first and fourth hydrogen stations 41 and 44 as candidates for hydrogen stations that are normally open and reachable in the vicinity of the reference driving route 50.

In steps S302 and S303 of FIG. 8, the navigation device 20 obtains the congestion status of the first and fourth hydrogen stations 41 and 44 from the congestion status database 34 of the management server 30 as in steps S105 and 106 of FIG. 4, and estimates the waiting time period is estimated. Then, the navigation device 20 searches for the first filling station inclusive driving route 51 and the fourth filling station inclusive driving route 54 in step 304 of FIG. 8, as in step 107 of FIG. 4. Then, in step S305 of FIG. 8, the navigation device 20 calculates, as in step S108 of FIG. 4, the required time period when driving to the destination 49 on the first filling station inclusive driving route 51. Also, in step S305 of FIG. 8, the navigation device 20 calculates the required time period in the case of driving to the destination 49 on the fourth filling station inclusive driving route 54.

Then, in step S306 of FIG. 8, the navigation device 20 provides route guidance using the fourth filling station inclusive driving route 54, which has the shortest required time period among the first filling station inclusive driving route 51 and the fourth filling station inclusive driving route 54.

The operation shown in FIG. 8 can search for the travel route with the shortest required time period with a simpler operation than the operation described with reference to FIG. 4.

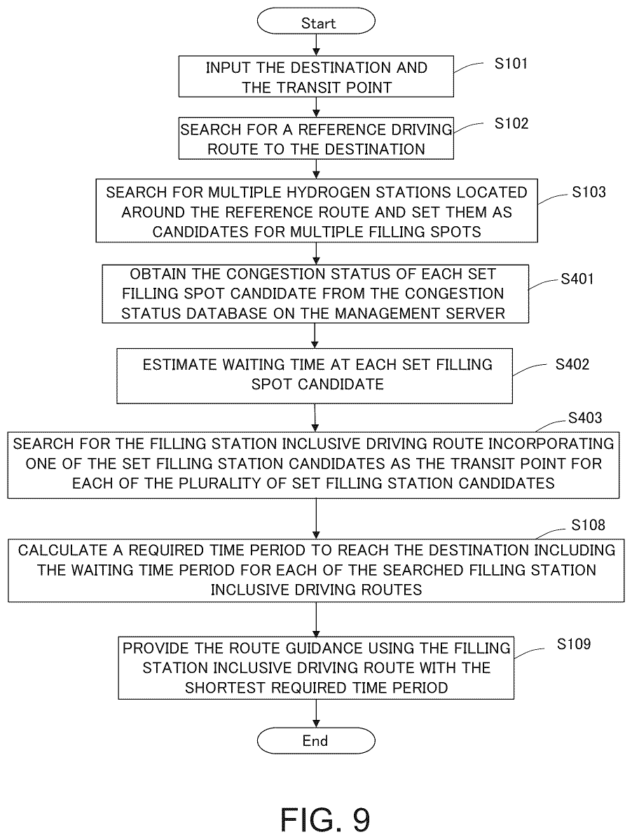

Next, other operations of the navigation device 20 are described with reference to FIG. 9. In this operation, when it is known that all the hydrogen stations are open and reachable, the filling station inclusive driving route is searched for each candidate charging station without resetting the candidate filling stations. Then, route guidance is performed using the filling station inclusive driving route with the shortest required time period to the destination 49. The operation of the navigation device 20 in this case is described with reference to FIG. 9. Operations similar to those described earlier with reference to FIG. 4 are described with the same step numbers.

The navigation device 20 sets the first to fourth hydrogen stations 41, 42, 43, and 44 as filling station candidates in step S103 of FIG. 9. The navigation device 20 then obtains the congestion status of the first to fourth hydrogen stations 41, 42, 43, and 44 from the congestion status database 34 of the management server 30 in steps S401 and S402 of

FIG. 9. This operation is similar to steps S105 and S106 in FIG. 4. The navigation device 20 then estimates the waiting time period. Then, the navigation device 20 searches for the first to fourth filling station inclusive driving routes 51, 52, 53, 54 in step 403 of FIG. 9. These operations are similar to step 107 in FIG. 4. Then, in step S108 of FIG. 9, the navigation device 20 calculates the required time period when driving to the destination 49 on the first to fourth filling station inclusive driving routes 51, 52, 53, 54. This operation is similar to step S108 in FIG. 4.

Then, the navigation device 20 executes route guidance using the filling station with the shortest required time period among the first to fourth filling station inclusive driving routes 51, 52, 53, 54 in step S109 of FIG. 9. This operation is similar to step S109 in FIG. 4.

The operation shown in FIG. 9 can search for the travel route with the shortest required time period with a simpler operation than the operation described with reference to FIG. 4.

In the above description, the electric vehicle is a FCEV 10 and the plurality of energy filling stations are described as a plurality of hydrogen stations, but are not limited to this. For example, the electric vehicle may be a battery electric vehicle (BEV) and the multiple energy filling stations may be multiple charging stations. In this case, the waiting time period is the waiting time period to start charging, and the required time period is the sum of the driving time to destination 49, the waiting time period to start charging at the charging station, and the charging time period.

In this case, the required time period can be shortened when the vehicle is recharged in the middle of the travel route and traveled to the destination 49.

1. A route guidance system comprising:
a navigation device that searches for a driving route to a destination based on the destination and a transit point, and provides route guidance using the searched driving route, the navigation device including a processor that performs information processing; and
a management server that manages an operational status of a plurality of energy filling stations, and stores a congestion status database in a memory that stores information, the congestion status database storing a congestion status of each of the plurality of energy filling stations, wherein
the processor
obtains the congestion status of each of the plurality of energy filling stations from the congestion status database of the management server; and
estimates a waiting time period at each of the plurality of energy filling stations based on the obtained congestion status;
for each of the plurality of energy filling stations, searches for a filling station inclusive driving route incorporating one of the plurality of energy filling stations as the transit point, and
calculates a required time period to reach the destination, including the waiting time period, for each of the searched filling station inclusive driving routes, and
provides the route guidance using the filling station inclusive driving route with the shortest required time period.

2. The route guidance system according to claim 1, wherein
the memory of the management server stores a service information database that includes a location and service information of each of the plurality of energy filling stations,
the processor
searches for a reference driving route to the destination based on the destination and the transit point;
obtains the location of each of the plurality of energy filling stations from the service information database of the management server;
searches for a plurality of energy filling stations located in the vicinity of the reference driving route; and
sets the searched plurality of energy filling stations as a plurality of filling station candidates; and
the obtaining the congestion status of each of the plurality of energy filling stations is to obtain the congestion status of each of the plurality of filling station candidates from the congestion status database of the management server, the estimating of the waiting time period is to estimate the waiting time period at each of the plurality of filling station candidates based on the obtained congestion status,
the searching for the filling station inclusive driving route is to search for the filling station inclusive driving route incorporating one of the plurality of filling station candidates as the transit point for each of the plurality of filling station candidates.

3. The route guidance system according to claim 2, wherein
the processor
after setting the plurality of filling station candidates, obtains the service information of each of the plurality of filling station candidates from the service information database of the management server; and
resets the plurality of filling station candidates by excluding out-of-service filling station candidates from the plurality of filling station candidates,
the obtaining of the congestion status of each of the plurality of energy filling stations is to obtain the congestion status of each of the plurality of reset filling station candidates from the congestion status database of the management server,
the estimating of the waiting time period is to estimate the waiting time period at each of the reset filling station candidates based on the obtained congestion status,
the searching for the filling station inclusive driving route is to search for the filling station inclusive driving route incorporating one of the reset filling station candidates as the transit point for each of the plurality of reset filling station candidates.

4. The route guidance system according to claim 3, wherein
in the congestion status database, the congestion status of each of the plurality of energy filling stations is associated with the day of the week and the time of day,
the processor searches a partial driving route to the plurality of reset filling station candidates and calculates the arrival time at each of the plurality of reset filling station candidates,
the estimating of the waiting time period is to refer to the congestion status database and estimate the waiting time period at the arrival time to the reset filling station candidate.

5. The route guidance system according to claim 1, wherein
the energy filling station is a charging station or a hydrogen station.

6. The route guidance system according to claim 2, wherein
the energy filling station is a charging station or a hydrogen station.

7. The route guidance system according to claim 3, wherein
the energy filling station is a charging station or a hydrogen station.

8. The route guidance system according to claim 4, wherein
the energy filling station is a charging station or a hydrogen station.
